(19) United States
(12) Patent Application Publication
(10) Pub. No.: US 2016/0272233 A1
(43) Pub. Date: Sep. 22, 2016

(54) Harness For Pulling a Trailer

(71) Applicant: Croozer GmbH, Cologne (DE)

(72) Inventors: Christian Harbeke, Zurich (CH); Lukas Thüring, Basel (CH); Linus Jeuch, Baden (CH)

(73) Assignee: Croozer GmbH, Cologne (DE)

(21) Appl. No.: 15/075,175

(22) Filed: Mar. 20, 2016

(30) Foreign Application Priority Data
Mar. 20, 2015 (DE) 102015104253.3
Apr. 15, 2015 (DE) 102015105748.4

(51) Int. Cl. B62B 5/06

(52) U.S. Cl. CPC B62B 5/068

(57) ABSTRACT

A harness for a trailer is described, in particular a trailer for transporting loads or children. The harness includes a hip belt and a linkage of drawbars attached thereto, with a right drawbar and a left drawbar which are connected to the hip belt in the region of their front ends in the pulling direction and which can be connected to a trailer at their rear ends in the pulling direction. In order to significantly improve the wearing comfort during pulling operation, the respective front end of each of the drawbars includes an arm piece which projects transversely therefrom and consists of a resilient material. The top of the arm piece that is remote from the drawbar includes fastening means for the connection thereof to the hip belt.

### CROSS-REFERENCE TO RELATED APPLICATIONS

This application claims priority to German Patent Application No. 102015104253.3 filed Mar. 20, 2015, and also claims priority to German Patent Application No. 102015105748.4 filed Apr. 15, 2015, each of which are incorporated herein by reference in their entirety.

### FIELD

The present invention relates to a harness for pulling a trailer, in particular a trailer for transporting loads or children, having a hip belt and a linkage of drawbars attached thereto, with a right drawbar and a left drawbar which are connected to the hip belt in the region of their front ends in the pulling direction and which can be connected to a trailer at their rear ends in the pulling direction.

### BACKGROUND

Various harnesses for bicycle trailers are known from the prior art. Under the trade mark Chariot®, a ski set is offered which consists of a pair of skis which can be placed in a bicycle trailer, and also a harness. The harness consists of a hip belt and a pair of telescopic bars. At their rear ends in the pulling direction, the telescopic bars can be connected to the front of a bicycle trailer. The front of the drawbars is firmly attached to the hip belt by a shaft piece which projects substantially horizontally from the hip belt and allows the drawbars to swivel vertically. The hip belt is buckled around the hips. With this ski set, while cross-country skiing, a cross-country skier is able to pull behind him the bicycle trailer equipped for this purpose with skis. One disadvantage of this harness is that the mobility of the cross-country skier is significantly restricted. Furthermore, particularly when starting to move and slowing down, the cross-country skier is subjected to considerable load changes due to the trailer. In addition, the pitching motions on the pulled trailer are relatively high, which particularly impairs the travel comfort experienced by children in the trailer.

The company Nordic Cab offers a further ski set with a harness which also has a hip belt with shoulder straps and a pair of telescopic bars. Unlike the telescopic bars of the ski set under the trade mark name Chariot®, the telescopic bars of Nordic Cab are formed at their front end in the pulling direction with an elongate resilient plastics piece which runs substantially in the direction of the telescopic bars. The elastomeric piece serves, inter alia, to bridge the difference between the horizontal distance of the drawbars and the broadness of the wearer of the hip belt. Linked in a freely swivellable and rotatable manner at the front end of the elastomeric piece is a snap hook which is hooked into a metal eyelet provided in each case in the side of the hip belt. To prevent the elastomeric piece from rubbing excessively against the body during the pulling operation, on its sides the hip belt has additional protective tabs. Nevertheless, the rubbing action can be troublesome. Although the pitching motions of the trailer which is pulled are relatively low during travel compared to the Chariot model, the damping characteristics during load changes from tension to compression are not optimum, not least because due to the snap hook which is freely inserted into the metal eyelet, an unbraked and undamped distance of several centimetres results during load changes, so that load changes can be transferred to the hip belt in a jerky manner. This can be perceived as being unpleasant.

### SUMMARY

In contrast thereto, the object of the present invention is to provide a harness, the wearing comfort of which in pulling operation is significantly improved.

This object is achieved according to an embodiment, wherein a harness of the type mentioned at the outset which has the features of Claim 1 is provided, namely in that provided on the respective front end of each of the drawbars is an arm piece which projects transversely therefrom and consists of a resilient material, the top of the arm piece, remote from the drawbar having fastening means for the connection thereof to the hip belt.

With the harness according to an embodiment, it is possible to clearly guide the drawbars under the hip belt and to thereby guide them below the hips. Consequently, the wearer's freedom of movement is restricted to a significantly lesser extent than in the case of the previously known harnesses. Furthermore, as a result of the resilient arm piece which extends transversely to the pulling direction, load changes acting on the hip belt and thereby on the wearer of the hip belt by the drawbar are damped particularly effectively because, unlike the elastomeric piece by Nordic Cab, the arm piece is not stretched and compressed, but during load changes it can deform substantially transversely to the pulling direction.

As in the previously known harnesses, telescopic bars can be used in particular as drawbars. They have the advantage that their length can be adapted to the purpose of use. For example, a longer length can be adjusted to create the necessary freedom of movement when the harness is used for pulling a trailer during cross-country skiing, or the drawbars can be shortened to use the harness while hiking since the wearer's legs do not require as much freedom of movement. A shorter length of the drawbars inevitably has the advantage that the team of puller and trailer becomes shorter and thereby more manoeuvrable. However, telescopic bars do not have to be used, simple bars which, if appropriate, can be put together and detached from one another again, are quite adequate.

The drawbars can be produced from a large number of suitable materials, in particular as a tube. In a cost-weight trade-off, the drawbars are usually produced at present from an aluminium tube material.

The drawbars do not necessarily have to be straight. They can also be curved or offset particularly in their rear region in the pulling direction in order to compensate for a possible difference in width between the mounts for the rear ends of the drawbars and the distance of the drawbars at their front ends which should be substantially slightly wider than an average hip belt wearer.

Each arm piece includes an angle of between 60° and 120° with the portion of the drawbar to which it is attached. The arm piece can project vertically in particular from the drawbar, or it can be inclined forwards or backwards with respect to the drawbar in the puling direction. It can also be curved forwards or backwards in the pulling direction. The angle is understood as meaning the angle between a centre axis of the arm piece which runs centrally through the attachment point of the arm piece to the hip belt and on the arm piece-side surface of the drawbar through the centre of the portion (viewed in the direction of the drawbar), by which the arm piece engages around the drawbar and at least rests against the drawbar.

In a further embodiment of the invention, each of the drawbars has a front tubular piece in the pulling direction to which the arm piece is attached and which is connected releasably to the rest of the drawbar. A releasable connection can be, for example, with single locking heads or with opposite locking heads in pairs which are spring-mounted on the tubular piece and which engage in corresponding mounts in the tube of the drawbar into which it is inserted.

Each of the arm pieces may be formed from rubber or from a rubber-containing composite material. Rubber is flexible and has a high durability even at varying temperatures and under a high continuous load.

In an embodiment, the cross section of the arm piece has a greater extent in the pulling direction than vertically to the pulling direction. This has the advantage that the arm piece is significantly more rigid in the pulling direction in which relatively high forces arise than transversely to the pulling direction. Thus, the forces in the pulling direction can be damped in an optimum manner. However, the extent of the cross section of the arm piece transversely to the pulling direction may be also calculated to be great enough for the arm piece not to sag, or in any case to sag only slightly towards the body and likewise for it not to twist or in any case to twist only slightly due to the forces acting thereon.

The cross section of the arm piece can be constant over the length thereof. However, it has proved to be advantageous if the cross section of the arm piece tapers towards the top particularly in its extent in the pulling direction. As a result, the arm piece becomes more deformable in the pulling direction towards the top.

In an embodiment, it is possible to provide in the top of each arm piece a passage hole transversely to the pulling direction, through which the hole at the top of each arm piece can be attached onto a shaft piece which is fastened to the hip belt and projects transversely therefrom and in particular can be fastened and removed again by means of a screw connection or a catch connection. This embodiment allows a secure connection and the arm piece is fastened to the hip belt such that it can rotate about the shaft without coming away.

As an alternative to this, the top of each arm piece can be connected to the hip belt by a clip buckle. In this respect, one part of the buckle can be attached to the hip belt via a short belt by means of a rivet, in which case it has a good rotational freedom. The counterpart of the buckle can for example be attached to the arm piece also by a belt using one or more rivets or screws.

In the region of the attachment of the arm pieces to the hip belt, the hip belt can be padded and/or reinforced on its inside facing the user. For this purpose, an elastomeric panel can be used, for example, which can be optimally adapted to the body shape of the wearer.

The hip belt has means for shortening or lengthening the back part thereof, and here “back part” is understood as meaning the part of the belt which, when put on by a user, runs along the user's back. A particularly practical means for shortening or lengthening the back part of the hip belt has proved to be a press stud system, by which loops of different lengths can be created to shorten the back part.

The wearing comfort of the harness can be greatly enhanced by at least one shoulder strap which is attached to the hip belt. As the result of a shoulder strap or a pair of shoulder straps, the vertical loads applied to the hip belt by the drawbars of the trailer can be distributed relatively uniformly over the hips and the shoulder(s) of the user.

To further simplify the handling of the harness according to the invention and to configure it to be more comfortable, a handle which surrounds in particular the drawbar can be configured on the drawbar-side part of each arm piece. The user can thus comfortably hold the drawbars by the handles, for example when the user would like to lift up the drawbars to connect them to the hip belt. The handles can also be helpful when hiking, because the user can either support his hands on the handles or can purposefully guide the trailer with his hands. Furthermore, the drawbars can be lifted up by the handles while hiking or cross-country skiing to thus relieve the hips and/or the shoulders of the user.

### BRIEF DESCRIPTION OF THE FIGURES

In the following, a more particular description will be described in more detail with reference to specific embodiments thereof that are illustrated in the appended figures.

FIG. 1 is a plan view of a bicycle trailer with drawbars of a harness according to an embodiment;

FIG. 2 is a side view of the bicycle trailer together with drawbar, shown in FIG. 1;

FIG. 3 is a side view of a part of the drawbar shown in FIG. 1;

FIG. 4 is a plan view of the drawbar shown in FIG. 3;

FIG. 5a is a side view of an arm piece of the harness according to the embodiment shown in FIG. 1;

FIG. 5b, 5c, 5d show cross sections of the arm piece shown in FIG. 5a;

FIG. 6 shows a hip belt according to a first embodiment ;

FIGS. 7a and 7b show a partial aspect of the hip belt shown in FIG. 6;

FIG. 8 shows a hip belt according to a second embodiment; and

FIG. 9 shows an embodiment of a connection of arm piece and hip belt.

### DETAILED DESCRIPTION

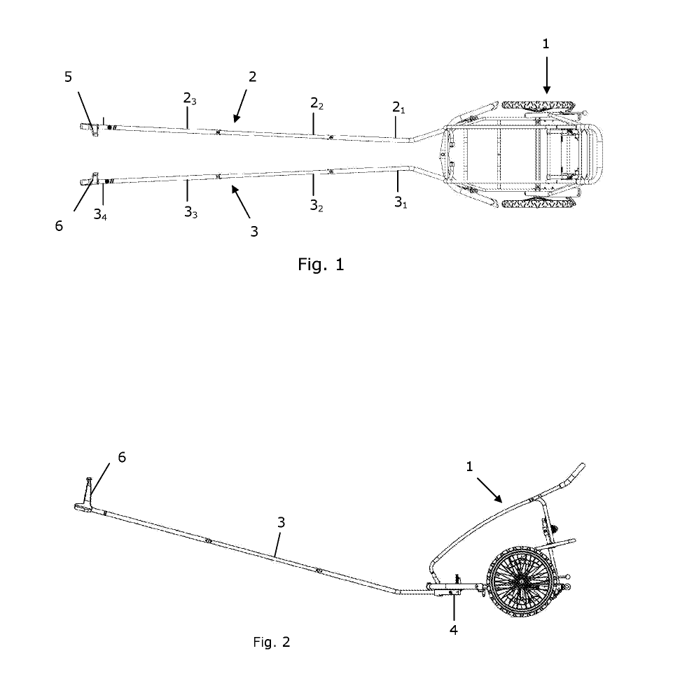

FIGS. 1 and 2 show the frame 1 of a multifunctional bicycle trailer. Two drawbars 2, 3 are attached to the front thereof. For attachment, the drawbars are inserted by their rear end in the pulling direction into mounts 4 which are also intended for receiving fork arms for a central front wheel. Provided at the front end of the drawbars are arm pieces 5, 6, by which the drawbars are connected to a hip belt (not shown here).

The drawbars 2, 3 each consist of four tubular pieces 21, 22, 23, 24, 31, 32, 33, 34. The individual tubular pieces of a drawbar can be inserted into one another and are fastened together by spring-mounted locking heads and by locking head mounts, provided therefor, in the tubes.

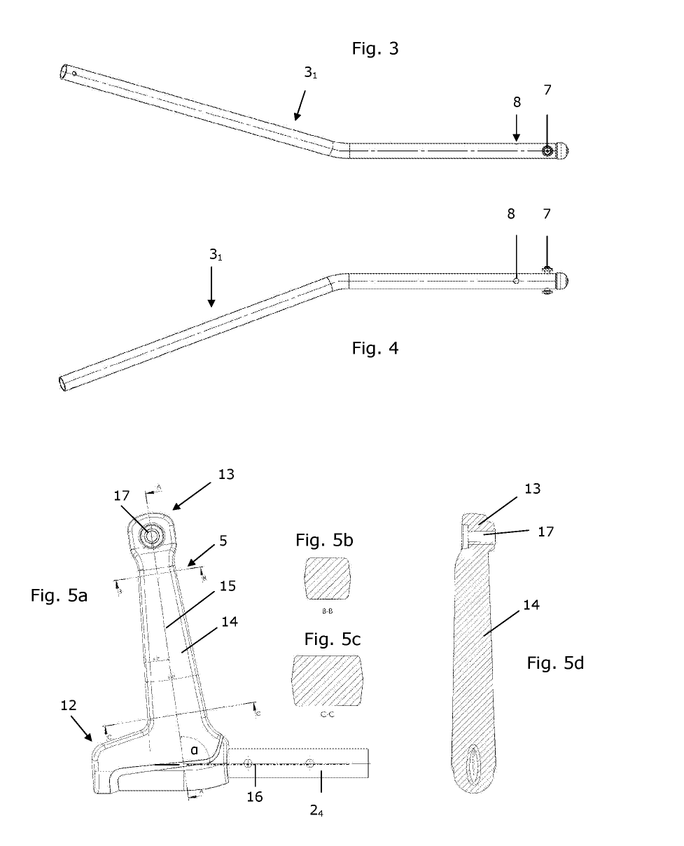

As can also be seen particularly in FIGS. 3 and 4, the rear tubular pieces 21, 31 have a curved portion in which they are bent slightly outwards in the horizontal. Furthermore, the drawbar 2, 3 is also slightly bent in the vertical here. As can be seen particularly in FIG. 1, the mounts 4 for the fork arms of the bicycle trailer 1 are such that the drawbars 2, 3, inserted therein, initially run towards one another. The curvature in the horizontal is selected such that the spacing of the drawbars at their front ends is wide enough for a person, the curvature in the vertical is such that when the bicycle trailer is standing horizontally, the drawbars 2, 3 with their front ends are approximately level slightly below the hips of a typical person.

The shaft piece 7 which is shown in FIGS. 3 and 4, is arranged at the rear end of the rear tubular piece 31 and extends transversely to the longitudinal direction thereof is used to position and lock the tubular piece in the fork mount 4, and the hole 8 is used to ensure that the drawbars cannot be mixed up in use.

FIGS. 5a and 5b show an embodiment of an arm piece 5 according to the invention. It has a portion 12 on the drawbar side, a top 13 and an interlying web 14. The portion 12 on the drawbar side surrounds the front end of the front tubular piece 24 of the drawbar 2. The web 14 which adjoins the drawbar-side portion 12 and is offset backwards is tilted slightly forwards. Its axis of symmetry 15 includes with the axis 16 of the front drawbar portion an angle α of approximately 100°. As can be seen in the sectional views A-A and B-B of FIGS. 5b and 5c and from the longitudinal sectional view 5d, the web 14 has a cross section which narrows towards the top 13, the almost rectangular cross section having a greater extent in the pulling direction than transversely thereto, and the thickness of the web 14 remaining substantially constant over its height.

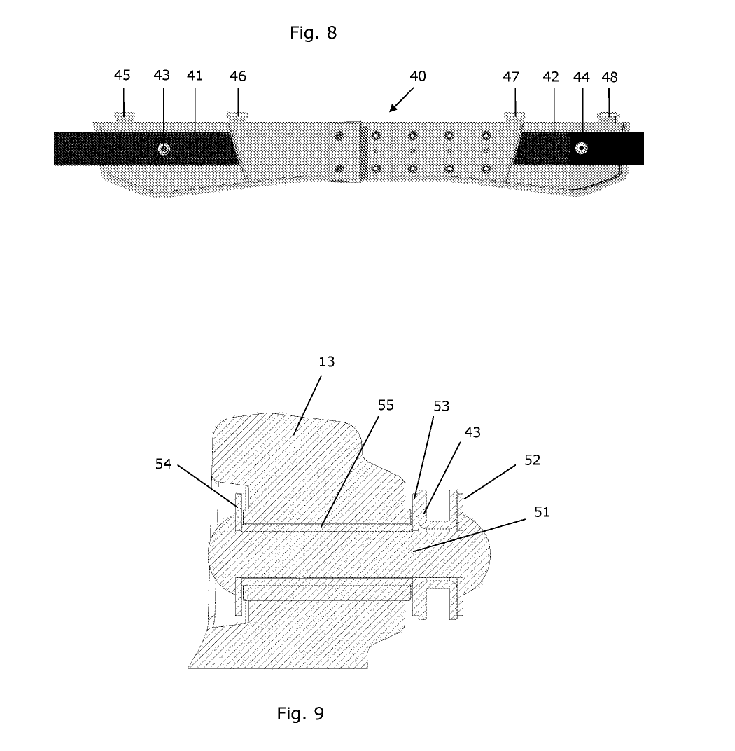

The web 14 of the arm piece 5 is inclined inwards by approximately 10° towards the wearer in the transverse direction to the pulling direction. The top 13 is tapered so that it can bend under the effect of relatively low forces and is substantially vertical in the position of use. The top 13 has a through hole 17 which serves as a mount for a shaft piece of a hip belt, as is described for example with reference to FIGS. 8 and 9.

If the front part of the drawbar-side portion 12 is long enough, it can be used as a handle and can be formed ergonomically for this purpose, if appropriate.

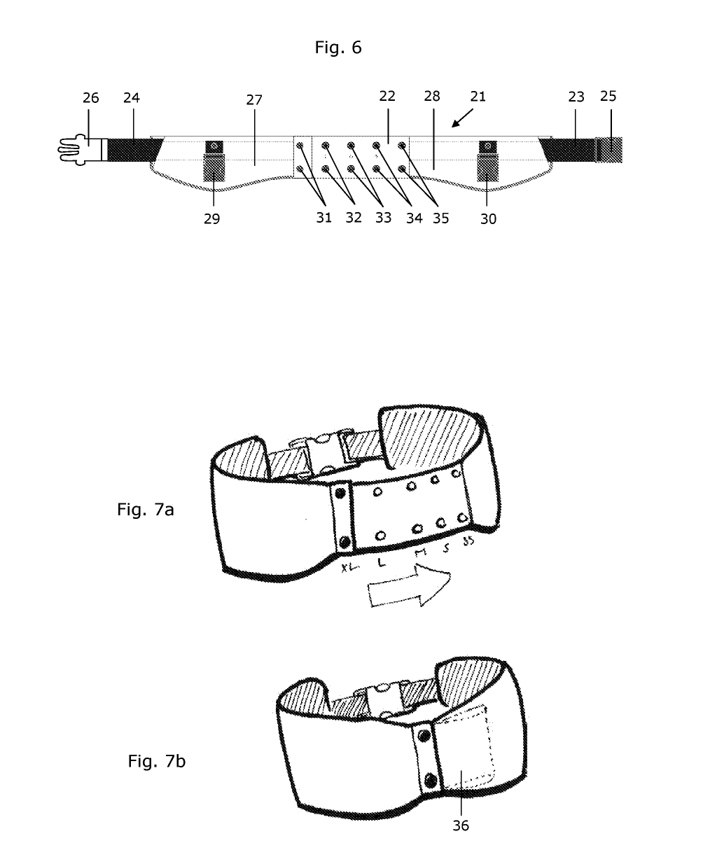

FIG. 6 shows a hip belt 21 suitable for a harness according to the invention. It has a central back portion 22 which is adjoined by the two sides of a respective belt 23, 24. Closures 25, 26 are provided at the free ends of the belts 23, 24. Portions of the belt have coverings 27, 28 which are padded on the inside and, like the belts 23, 24 are joined to the back portion 22. Attached to each of the coverings 27, 28 is a respective clip buckle element 29, 30 which is provided to cooperate with a buckle element, attached to the top of an arm piece, to fasten the arm piece to the hip belt.

Arranged in a superimposed manner on the back portion 22 of the hip belt 21 are a pair of press stud elements 31 which can cooperate with pairs of press stud elements 32, 33, 34, 35 which are arranged in uniform spacings on one side of said back portion. As can be seen in FIGS. 7a and 7b, a loop 36 can be formed by pressing the press stud elements 31 onto the press stud elements 32, 33, 34 or 35 in the back piece 22 in order to adjust the circumference of the hip belt.

The hip belt 40 shown in FIG. 8 differs from the hip belt shown in FIG. 6 in that each of the belts 41, 42 has, instead of clip buckle elements, a respective eyelet 43, 44 for receiving a shaft piece to attach the top of an arm piece. The hip belt shown in FIG. 8 also differs from the one shown in FIG. 6 in that belt eyelets 45-48 are provided in the upper edge thereof to attach shoulder straps (not shown here).

FIG. 9 shows a connection between the hip belt shown in FIG. 8 and the arm piece shown in FIG. 5. Here, the shaft piece is formed as a rivet 51, but it can be formed just as well, for example, by a screw and a nut positioned thereon. The rivet 51 or screw is guided through the eyelet 43, the eyelet 43 being positioned between two washers 52, 53.

Arranged between the washer 53 and a further washer 54 is a bushing 55 which sits on the rivet bolt or on the threaded bolt and is guided though the through hole 17 in the top 13 of the arm piece 5, 6. The length of the rivet 51 is calculated such that the top 13 of the arm piece 5, 6 and the eyelet 43 of the hip belt 40 sit thereon with a slight lateral clearance so that they can freely swivel about the shaft piece.

What is claimed is:

1. A harness for pulling a trailer, the harness comprising:
a hip belt; and
a linkage of drawbars attached thereto with a right drawbar and a left drawbar which are connected to the hip belt in a region of their front ends in a pulling direction and which can be connected to the trailer at their rear ends in the pulling direction, wherein the respective front end of each of the drawbars is an arm piece which projects transversely therefrom and consists of a resilient material, a top of the arm piece, remote from the drawbar having a fastening means for the connection thereof to the hip belt.

2. The harness of claim 1, wherein each arm piece includes an angle between 60° and 120° with a portion of the drawbar to which it is attached.

3. The harness of claim 1, wherein each of the drawbars has a front tubular piece in the pulling direction, to which the arm piece is attached and which is releasably connected to the rest of the drawbar.

4. The harness of claim 1, wherein each of the arm pieces is formed from a rubber or from a rubber-containing composite material.

5. The harness of claim 1, wherein a cross section of the arm piece has a greater extent in the pulling direction than vertically to the pulling direction.

6. The harness of claim 1, wherein a cross section of the arm piece narrows towards the top particularly in its extent in the pulling direction.

7. The harness of claim 1, wherein the arm piece is curved towards the top transversely to the pulling direction.

8. The harness of claim 6, wherein the arm piece is curved towards the top transversely to the pulling direction.

9. The harness of claim 1, wherein the top of each arm piece comprises a through hole transversely to the pulling direction, by which the top can be attached to a shaft piece which is attached to the hip belt and projects transversely therefrom and can be fixed and detached therefrom again in particular by a screw connection or by a locking connection.

10. The harness of claim 1, wherein the top of each arm piece is connected to the hip belt by a clip buckle.

11. The harness of claim 1, wherein the hip belt is padded and/or reinforced on its inside in the region of the attachment of the arm pieces.

12. The harness of claim 1, wherein the hip belt has a means for shortening or lengthening a back part thereof.

13. The harness of claim 1, further comprising at least one shoulder strap attached to the hip belt.

14. The harness of claim 1, further comprising a handle surrounding the drawbar formed on a drawbar-side part of each arm piece.

15. The harness of claim 1, wherein the trailer is a trailer configured for transporting loads or children.

16. A harness for pulling a trailer, the harness comprising:
a hip belt; and
a linkage of drawbars attached thereto with a right drawbar and a left drawbar which are connected to the hip belt in a region of their front ends in the pulling direction and which can be connected to the trailer at their rear ends in the pulling direction, wherein at the respective front end of each of the drawbars is an arm piece which projects transversely therefrom and consists of a resilient material, a top of the arm piece remote from the drawbar having fastening means for the connection thereof to the hip belt, a cross section of the arm piece has a greater extent in the pulling direction than vertically to the pulling direction, and the arm piece is curved towards the top transversely to the pulling direction.

17. The harness of claim 16, wherein each of the arm pieces includes an angle between 60° and 120° with a portion of the drawbar to which it is attached and each of the drawbars has a front tubular piece in the pulling direction, to which the arm piece is attached and which is releasably connected to the rest of the drawbar.

18. The harness of claim 16, wherein the top of each arm piece comprises a through hole transversely to the pulling direction, by which the top can be attached to a shaft piece which is attached to the hip belt and projects transversely therefrom and can be fixed and detached therefrom again in particular by a screw connection or by a locking connection

19. A harness for pulling a trailer, the harness comprising:
a hip belt having a press stud system configured to create loops of different lengths, wherein the hip belt is padded and/or reinforced on an inside facing a user; and
a linkage of drawbars attached thereto with a right drawbar and a left drawbar which are connected to the hip belt in a region of their front ends in the pulling direction and which can be connected to the trailer at their rear ends in the pulling direction, wherein at the respective front end of each of the drawbars is an arm piece which projects transversely therefrom and consists of a resilient material, a top of the arm piece remote from the drawbar having fastening means for the connection thereof to the hip belt.

20. The harness of claim 19, wherein a cross section of the arm piece has a greater extent in the pulling direction than vertically to the pulling direction, and wherein the cross section of the arm piece narrows towards the top particularly in its extent in the pulling direction.
